(19) United States
(12) Patent Application Publication
(10) Pub. No.: US 2026/0058443 A1
(43) Pub. Date: Feb. 26, 2026

(54) SPARK PLUG HAVING IMPROVED SEALING PROPERTIES

(71) Applicant: Robert Bosch GmbH, Stuttgart (DE)

(72) Inventor: Roman Kireev, Engels, Saratovskaya Oblast (RU)

(21) Appl. No.: 19/099,488

(22) PCT Filed: Jul. 20, 2023
(86) PCT No.: PCT/EP2023/070098

§ 371 Date: Jan. 29, 2025

(30) Foreign Application Priority Data
Aug. 26, 2022 (DE) 10 2022 208 848.4

(51) Int. Cl. H01T 13/08

(52) U.S. Cl. CPC H01T 13/08

(57) ABSTRACT

A spark plug. The spark plug includes a central electrode and a ground electrode, an insulator, a metal housing, and a metal sealing ring arranged on an outer side of the housing and configured to seal off at a cylinder head. The sealing ring has a first ring region oriented perpendicularly to a central axis of the spark plug and a second ring region oriented at an acute angle to the central axis of the spark plug. The first ring region is parallel to a shoulder on the housing and the second ring region is arranged on the inner circumference of the first ring region.

### FIELD

The present invention relates to a spark plug having improved sealing properties on an outer housing of the spark plug when the spark plug is screwed onto a cylinder head or the like, for example.

### BACKGROUND INFORMATION

Spark plugs in different designs are described in the related art. One problem concerning spark plugs is that the spark plug, which is located in a spark plug bore in a cylinder head, must also provide a seal on the outer circumference of the spark plug between the spark plug and the cylinder head. A washer-like sealing ring made of metal is usually used for this purpose. For example, Germany Patent Application No. DE 10 2016 110 880 A1 describes a spark plug having a sealing ring in the form of a washer that is pushed onto a housing and shrunk in a subsequent post-forming step in order to be held on the spark plug so as not to be lost over a threaded portion of the housing.

### BACKGROUND INFORMATION

A spark plug according to the present invention may have the advantage that a seal between the spark plug and a cylinder head is significantly improved by means of a metal sealing ring. This can safely prevent gases from the combustion chamber from reaching the outside via the gap between the cylinder head and the spark plug. This is achieved according to the present invention in that the spark plug has a central electrode and a ground electrode between which an ignition gap is formed. The spark plug further comprises an insulator and a metal housing, and a metal sealing ring arranged on the outer side of the housing. The sealing ring is designed for sealing off between the cylinder head and the spark plug. The metal sealing ring has a first ring region and a second ring region. The first ring region is oriented perpendicularly to a central axis X-X of the spark plug and the second ring region is oriented at an acute angle a to the central axis X-X of the spark plug. The first ring region, which is oriented perpendicularly to the central axis, is oriented parallel to a shoulder on the housing. The second ring region is arranged on the inner circumference of the first ring region. The first and second ring regions of the metal sealing ring thus ensure that there is not only a seal in a plane perpendicular to the central axis of the spark plug, as with a washer, but that two different sealing regions are provided on the metal sealing ring. A first sealing region on the first ring region of the sealing ring is perpendicular to the central axis of the spark plug and is therefore provided as a sealing ring when a washer is used, as in the related art. The second ring region is arranged at an acute angle a to the central axis, so that an additional second sealing region is achieved in a different plane. The second sealing region on the second ring region is conical. This means that the overall sealing surface between the metal sealing ring and the spark plug or cylinder head can also be increased.

Preferred developments of the present invention are disclosed herein.

According to an example embodiment of the present invention, preferably, the housing has a recess in which the sealing ring is fully arranged. This means that the metal sealing ring can be positioned on the spark plug housing in a loss-proof manner, which significantly simplifies installation of the spark plug. The metal sealing ring is thus integrated into the housing by the formation of the recess in the housing.

Preferably, a thread for screwing the spark plug into the cylinder head is formed adjacent to the recess in the housing in the combustion-chamber-side direction of the spark plug.

Further preferably, the recess formed in the housing is designed as a circumferential groove having a first and second wall and a bottom having three bottom regions. The first wall is preferably oriented parallel to the central axis of the spark plug. The second wall is preferably angled or oriented at a right angle to the central axis of the spark plug. The three bottom regions are preferably arranged such that the bottom has a first region perpendicular to the central axis, a second region parallel to the central axis, and a third region that is arranged at an angle to the central axis and connects the first and second regions to one another.

According to a particularly preferred example embodiment of the present invention, a surface roughness of the metal sealing ring is greater than a surface roughness of the housing and/or the cylinder head. The different surface roughnesses result in improved sealing when installing the spark plug, since the greater surface roughness increases the sealing surface between the housing and the metal sealing ring as well as between the metal sealing ring and the cylinder head.

Further preferably, the structure of the metal sealing ring is such that a first leg length L1 of the first ring region is greater than or equal to a second leg length L2 of the second ring region.

Further preferably, the first and second ring regions of the metal sealing ring have the same thickness and/or the same mass. The angle a between the second ring region and the central axis is preferably in a range of 40° to 50° and is particularly preferably 45°.

According to an example embodiment of the present invention, the spark plug is preferably a hook spark plug or a pre-chamber spark plug or a spark plug having an ignition gap inside the housing. The housing of the spark plug is preferably made of a metal material, wherein the housing preferably has a greater hardness than the metal sealing ring.

### BRIEF DESCRIPTION OF THE DRAWINGS

With reference to the figures, a preferred exemplary embodiment of the present invention is described in detail below.

FIG. 1 is a schematic, partly sectional view of a spark plug according to a preferred exemplary embodiment of the present invention.

FIG. 2 is a schematic representation in a sectional view of an installed spark plug in a cylinder head, wherein for better clarity only the cylinder head, the housing, and the sealing ring are shown, according to an example embodiment of the present invention.

FIG. 3 is a schematic sectional view of the metal sealing ring of FIGS. 1 and 2.

### DETAILED DESCRIPTION OF EXAMPLE EMBODIMENTS

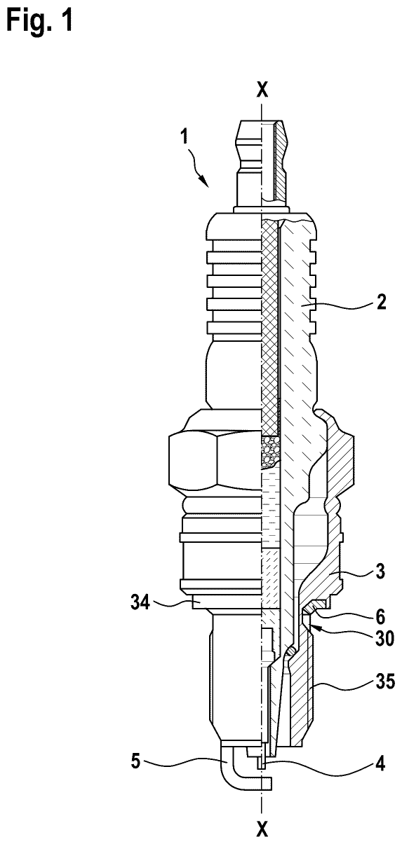

A spark plug 1 according to a preferred exemplary embodiment of the present invention is described in detail below with reference to FIG. 1 to 3.

As can be seen from FIG. 1, the spark plug 1 is a hook spark plug having an insulator 2, preferably made of a ceramic material, and a metal housing 3. The spark plug 1 further comprises a central electrode 4 and a ground electrode 5, which are connected to the housing 3. An ignition gap is formed between the central electrode 4 and the ground electrode 5 in a conventional manner.

The spark plug 1 further comprises a metal sealing ring 6 arranged on an outer side of the housing 3. The metal sealing ring 6 is designed for sealing off at a cylinder head 8.

The sealing by means of the metal sealing ring 6 is necessary to prevent gases from the combustion chamber from reaching the environment via the gap between the spark plug 1 and the cylinder head 8.

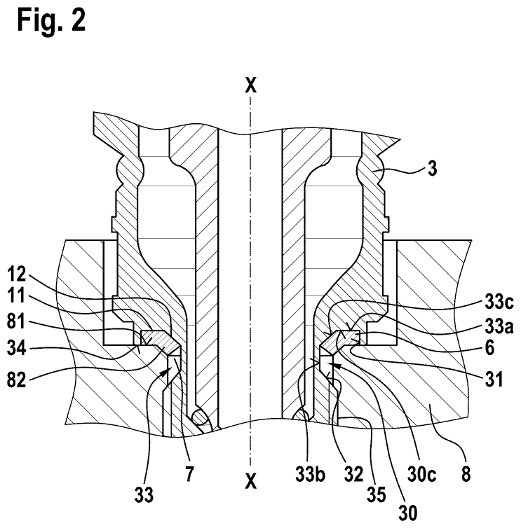

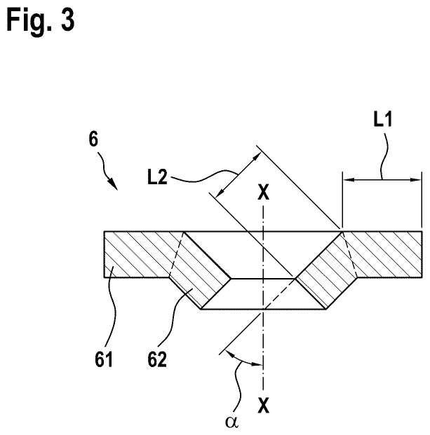

The metal sealing ring 6 can be seen in detail from FIGS. 2 and 3. The sealing ring 6 comprises a first ring region 61 and a second ring region 62 and is designed as a one-piece component. The second ring region 62 is arranged on the inner circumference of the first ring region 61.

The first ring region 61 and the second ring region 62 are arranged such that the first ring region 61 is arranged perpendicularly to a central axis X-X and the second ring region 62 is arranged at an acute angle a of 45° to the central axis X-X. As can be seen from FIG. 3, a first leg length L1 of the first ring region 61 is equal to a second leg length L2 of the second ring region 62.

The metal sealing ring 6 having first and second ring regions 61, 62 can be produced, for example, by a forming process.

As can be seen in particular from FIGS. 1 and 2, a recess 30 for receiving the metal sealing ring 6 is formed in the housing 3. The recess 30 in the housing 3 is arranged in a transition region between a shoulder 34 of the housing 3 and a fixing region 35, in particular a threaded region, of the housing 3 for fixing the spark plug on the cylinder head 8.

The recess 30 comprises a first wall 31 oriented parallel to the central axis X-X of the spark plug, a second wall 32 oriented perpendicularly or at an angle, in particular by 45°, to the central axis X-X, and a bottom 33. The bottom 33 connects the first wall 31 to the second wall 32.

The bottom 33 comprises a first region 33a perpendicular to the central axis X-X, a second region 33b parallel to the central axis X-X, and a third region 33c at an acute angle to the central axis X-X, wherein the third region 33c connects the first region to the second region. The angle corresponds to the angle a on the metal sealing ring between the first and the second ring region 61, 62.

As can be seen in particular from FIG. 2, the metal sealing ring 6 is fully received in the recess 30. As a result, the metal sealing ring 6 is positioned on the housing 3 in a loss-proof manner. This facilitates the installation of the spark plug in the cylinder head 8.

As can be seen from FIG. 2, when the metal sealing ring 6 is installed, an empty receiving region 7 is formed in the recess 30. The receiving region 7 is formed substantially on the second region 30b of the recess 30 and acts as a free region for receiving material that is displaced during installation of the spark plug in the cylinder head 8 due to deformation of the metal sealing ring 6.

As can be seen from FIG. 2, in the installed state of the spark plug 1 in the cylinder head 8, a first sealing region 11 is formed between the first ring region 61 and a sealing shoulder 81 on the cylinder head 8, as well as a second sealing region 12 between a chamfer 82 on the cylinder head and the second ring region 62. Thus, a sealing surface between the sealing ring 6 and the cylinder head 8 can be enlarged.

Furthermore, a surface roughness of the sealing ring 6 is greater than a surface roughness of the cylinder head 8. This further increases the tightness between the sealing ring and the cylinder head.

The surface roughness of the sealing ring 6 is also preferably greater than a surface roughness of the housing 3, whereby the seal between the housing and the sealing ring 6 is also improved. Furthermore, the design according to the present invention of the sealing ring 6 allows improved heat transfer between the spark plug and the cylinder head.

The receiving region 7 in the recess 30 further allows a defined deformation of the sealing ring 6 to take place during installation, so that a secure seal between the spark plug and the cylinder head is possible. Installing the sealing ring 6 in the recess is also very simple. Furthermore, by placing the sealing ring 6 in the recess 30, no further step, such as shrinking or the like, has to be carried out in order to install the sealing ring 6 on the spark plug in a loss-proof manner.

1-9. (canceled)

10. A spark plug, comprising:
a central electrode and a ground electrode;
an insulator;
a metal housing; and
a metal sealing ring arranged on an outer side of the housing and configured to seal off at a cylinder head;
wherein the sealing ring has a first ring region oriented perpendicularly to a central axis of the spark plug and a second ring region oriented at an acute angle to the central axis of the spark plug, wherein the first ring region is parallel to a shoulder on the housing and the second ring region is arranged on an inner circumference of the first ring region.

11. The spark plug according to claim 10, wherein the housing has a recess in which the metal sealing ring is fully arranged.

12. The spark plug according to claim 11, wherein the recess in the housing is a circumferential groove having a first wall, a second wall, and a bottom having three bottom regions.

13. The spark plug according to claim 12, wherein the bottom has a first region perpendicular to the central axis, a second region parallel to the central axis, and a third region at an acute angle to the central axis, wherein the third region connects the first region to the second region.

14. The spark plug according to claim 13, wherein the recess has a receiving region which is not filled by the sealing ring and which is configured as a material receiving region in order to receive a material of the sealing ring deformed during installation of the spark plug on the cylinder head.

15. The spark plug according to claim 10, wherein a surface roughness of the sealing ring is greater than a surface roughness of the housing and/or a surface roughness of the cylinder head.

16. The spark plug according to claim 10, wherein a first leg length of the first ring region is greater than or equal to a second leg length of the second ring region.

17. The spark plug according to claim 10, wherein the first ring region and the second ring region have an equal thickness and/or wherein the first ring region and the second ring region have an equal mass.

18. The spark plug according to claim 10, wherein the acute angle between the first ring region and the second ring region is 45°.
